(19) United States
(12) Patent Application Publication
(10) Pub. No.: US 2024/0328953 A1
(43) Pub. Date: Oct. 3, 2024

(54) ELECTRIC FIELD ENHANCING ELEMENT AND RAMAN SPECTROSCOPIC DEVICE

(71) Applicant: SEIKO EPSON CORPORATION, Tokyo (JP)

(72) Inventors: Hayato MATSUKI, SUWA-SHI (JP); Fumika YAMADA, SHIOJIRI-SHI (JP); Yoshitaka ITO, MATSUMOTO-SHI (JP)

(73) Assignee: SEIKO EPSON CORPORATION, Tokyo (JP)

(21) Appl. No.: 18/621,001

(22) Filed: Mar. 28, 2024

(30) Foreign Application Priority Data
Mar. 30, 2023 (JP) 2023-055937

(51) Int. Cl. G01N 21/65

(52) U.S. Cl. CPC G01N 21/658

(57) ABSTRACT

An electric field enhancing element includes a substrate, a plurality of microstructures provided at the substrate and having conductivity, and a transparent layer covering the plurality of microstructures and the substrate. An enhanced electric field generated by the plurality of microstructures is at a maximum at a position on an opposite side of the plurality of microstructures from the substrate and separated from the plurality of microstructures, in a perpendicular line direction of the substrate.

The present application is based on, and claims priority from JP Application Serial Number 2023-055937, filed Mar. 30, 2023, the disclosure of which is hereby incorporated by reference herein in its entirety.

### BACKGROUND

### 1. Technical Field

The present disclosure relates to an electric field enhancing element and a Raman spectroscopic device.

### 2. Related Art

In recent years, a Raman spectroscopic device using localized surface plasmon resonance (LSPR) has been known as one of spectroscopic techniques for detecting sample molecules of a low concentration. In such a Raman spectroscopic device, an enhanced electric field is formed by an electric field enhancing element having a nanometer-scale uneven structure, and surface enhanced Raman scattering (SERS) occurs in which Raman scattering light is enhanced.

For example, JP-A-2013-96939 describes an optical device including a substrate, a metal microstructure formed at a surface of the substrate and constituted by a plurality of metal particles, and an organic molecular film formed on the metal microstructure.

In the optical device as described above, it is desired to improve detection sensitivity.

### SUMMARY

In an aspect of the present disclosure, an electric field enhancing element includes a substrate, a plurality of microstructures provided at the substrate and having conductivity, and a transparent layer covering the plurality of microstructures and the substrate. An enhanced electric field generated by the plurality of microstructures is at a maximum at a position on an opposite side of the plurality of microstructures from the substrate and separated from the plurality of microstructures, in a perpendicular line direction of the substrate.

In an aspect of the present disclosure, a Raman spectroscopic device includes an aspect of the electric field enhancing element, a light source configured to irradiate the electric field enhancing element with light, and a detector configured to detect light from the electric field enhancing element.

### BRIEF DESCRIPTION OF THE DRAWINGS

FIG. 1 is a cross-sectional view schematically illustrating an electric field enhancing element according to an embodiment.

FIG. 2 is a plan view schematically illustrating the electric field enhancing element according to the embodiment.

FIG. 3 is a plan view schematically illustrating the electric field enhancing element according to the embodiment.

FIG. 4 is a plan view schematically illustrating the electric field enhancing element according to the embodiment.

FIG. 5 a plan view schematically illustrating the electric field enhancing element according to the embodiment.

FIG. 6 is a plan view schematically illustrating the electric field enhancing element according to the embodiment.

FIG. 7 is a diagram for describing plasmon resonance in the electric field enhancing element according to the embodiment.

FIG. 8 is a diagram for describing the plasmon resonance in the electric field enhancing element according to the embodiment.

FIG. 9 is a diagram for describing an enhanced electric field generated by a plurality of microstructures of the electric field enhancing element according to the embodiment.

FIG. 10 is a cross-sectional view schematically illustrating an electric field enhancing element according to a modified example of the embodiment.

FIG. 11 is a cross-sectional view schematically illustrating a Raman spectroscopic device according to the embodiment.

FIG. 12 is a diagram for describing a principle of a Raman scattering spectroscopy method.

FIG. 13 is a schematic diagram showing an example of a Raman spectrum obtained by Raman scattering spectroscopy.

FIG. 14 is an XZ cross-sectional view schematically illustrating a model used in a simulation.

FIG. 15 is an XY cross-sectional view schematically illustrating the model used in the simulation.

FIG. 16 is an XY cross-sectional view schematically illustrating the model used in the simulation.

FIG. 17 is an XZ cross-sectional view schematically illustrating the model used in the simulation.

FIG. 18 is a table showing dimensions and main parameters changed in Examples 1 to 16 and Comparative Example 1.

FIG. 19 shows simulation results of Example 1.

FIG. 20 shows simulation results of Example 2.

FIG. 21 shows simulation results of Example 3.

FIG. 22 shows simulation results of Example 4.

FIG. 23 shows simulation results of Example 5.

FIG. 24 shows simulation results of Example 6.

FIG. 25 shows simulation results of Example 7.

FIG. 26 shows simulation results of Example 8.

FIG. 27 shows simulation results of Example 9.

FIG. 28 shows simulation results of Example 10.

FIG. 29 shows simulation results of Example 11.

FIG. 30 shows simulation results of Example 12.

FIG. 31 shows simulation results of Example 13.

FIG. 32 shows simulation results of Example 14.

FIG. 33 shows simulation results of Example 15.

FIG. 34 shows simulation results of Example 16.

FIG. 35 shows simulation results of Comparative Example 1.

### DESCRIPTION OF EMBODIMENTS

A preferred embodiment of the present disclosure will be described in detail below with reference to the drawings. Also, the embodiment described below does not unduly limit the content of the present disclosure described in the claims. In addition, not all the configurations described below are essential constituent elements of the present disclosure.

### 1. Electric Field Enhancing Element

### 1.1. Configuration

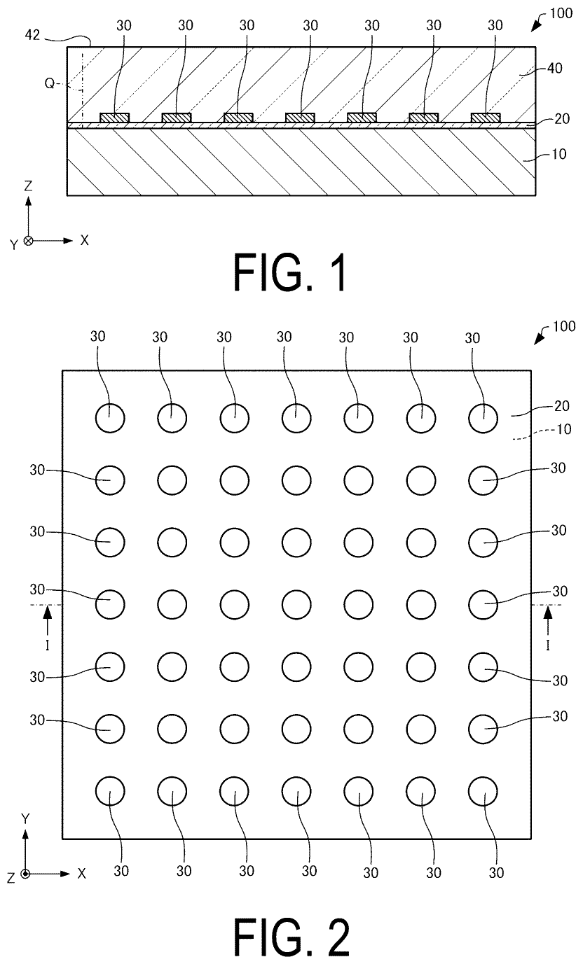

First, an electric field enhancing element according to an embodiment will be described with reference to the drawings. FIG. 1 is a cross-sectional view schematically illustrating an electric field enhancing element 100 according to the embodiment. FIG. 2 is a plan view schematically illustrating the electric field enhancing element 100 according to the embodiment. Note that FIG. 1 is a cross-sectional view taken along line I-I in FIG. 2. In FIGS. 1 and 2, an X axis, a Y axis, and a Z axis are illustrated as three axes orthogonal to each other.

As illustrated in FIGS. 1 and 2, the electric field enhancing element 100 includes a substrate 10, a dielectric layer 20, microstructures 30, and a transparent layer 40. Note that, for the sake of convenience, the transparent layer 40 is not illustrated in FIG. 2.

The substrate 10 supports the microstructure 30 via the dielectric layer 20. When light from a light source (not illustrated in FIGS. 1 and 2) used for Raman scattering (hereinafter, simply referred to as a “light source”) is incident from the substrate 10 side, the substrate 10 transmits the light. When the light from the light source is incident from the transparent layer 40 side, the substrate 10 may reflect the light toward the transparent layer 40 side.

The substrate 10 is, for example, a glass substrate or a silicon substrate. The material of the substrate 10 is, for example, SiO₂ or Si. The substrate 10 has a perpendicular line Q. The perpendicular line Q is a perpendicular line with respect to the upper surface of the substrate 10. In the illustrated example, the perpendicular line Q is in parallel with the Z axis, and thus a perpendicular line Q direction is a Z axis direction.

As illustrated in FIG. 1, the dielectric layer 20 is provided on the substrate 10. The dielectric layer 20 is provided between the substrate 10 and the microstructure 30. The thickness of the dielectric layer 20 is, for example, 1 nm or more and 2000 nm or less, and is preferably 10 nm or more and 1000 nm or less. Note that the dielectric layer 20 may not be provided.

The dielectric layer 20 is transparent with respect to the light from the light source. The material of the dielectric layer 20 is, for example, Al₂O₃, TiO₂, MgO, LiNbO₃, HfO₂, Ta₂O₅, SiON, Si₃N₄, or the like. The dielectric layer 20 may be constituted by a plurality of layers. In this case, the materials of the plurality of layers may be different from each other.

The microstructure 30 is provided on the dielectric layer 20. The microstructure 30 is provided at the substrate 10 via the dielectric layer 20. The microstructure 30 is provided between the dielectric layer 20 and the transparent layer 40. The shape of the microstructure 30 is, for example, a cylindrical shape. The diameter of the microstructure 30 is, for example, 1 nm or more and 1000 nm or less, is preferably 5 nm or more and 500 nm or less, and is more preferably 10 nm or more and 400 nm or less.

Note that the “diameter of the microstructure 30” is a diameter when the planar shape of the microstructure 30 is a circle, and is a diameter of the minimum inclusion circle when the planar shape of the microstructure 30 is a shape other than the circle. For example, when the planar shape of the microstructure 30 is a polygon, the diameter of the microstructure 30 is the diameter of the smallest circle that includes the polygon therein. When the planar shape of the microstructure 30 is an ellipse, the diameter of the microstructure 30 is the diameter of the smallest circle that includes the ellipse therein.

A plurality of the microstructures 30 are provided. The plurality of microstructures 30 are separated from each other. The transparent layer 40 is provided between the microstructures 30 adjacent to each other. The distance between the adjacent microstructures 30 is, for example, 20 nm or more and 1000 nm or less, and is preferably 100 nm or more and 900 nm or less. The plurality of microstructures 30 are arrayed at a predetermined pitch in a predetermined direction when viewed from the Z-axis direction. The plurality of microstructures 30 are provided periodically. In the example illustrated in FIG. 2, the plurality of microstructures 30 are arrayed in a square lattice pattern.

Note that the “pitch of the microstructures 30” is a distance between the centers of the adjacent microstructures 30 in the predetermined direction. The “center of the microstructure 30” is a center of a circle when the planar shape of the microstructure 30 is a circle, and is a center of the minimum inclusion circle when the planar shape of the microstructure 30 is a shape other than the circle. For example, when the planar shape of the microstructure 30 is a polygon, the center of the microstructure 30 is the center of the smallest circle that includes the polygon therein. When the planar shape of the microstructure 30 is an ellipse, the center of microstructure 30 is the center of the smallest circle that includes the ellipse therein.

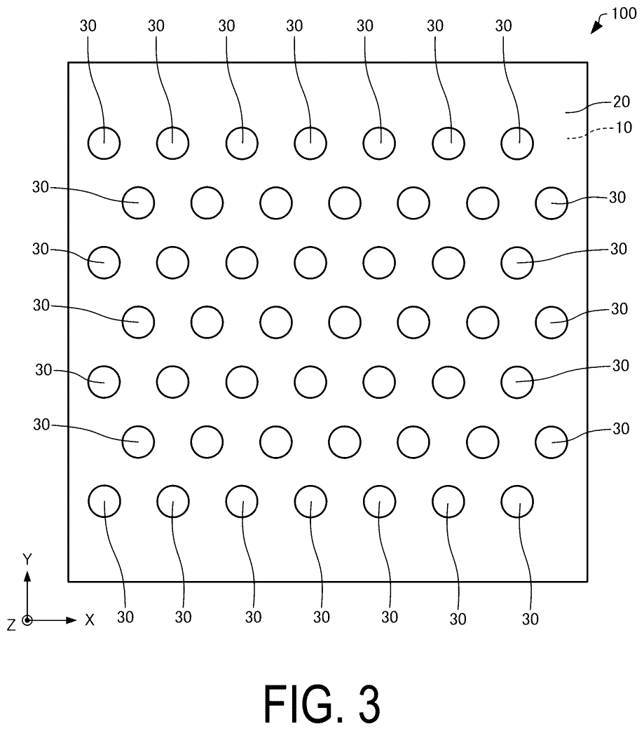

As illustrated in FIG. 3, the plurality of microstructures 30 may be provided in a triangular lattice pattern when viewed from the Z-axis direction. Further, although not illustrated, the periodicity of the plurality of microstructures 30 may expand or contract at a constant rate, and the plurality of microstructures 30 may include a fractal structure.

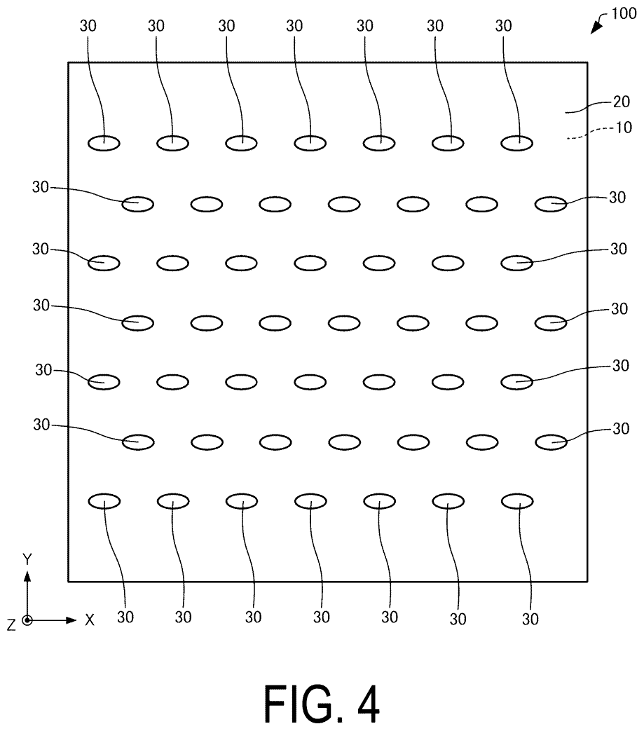

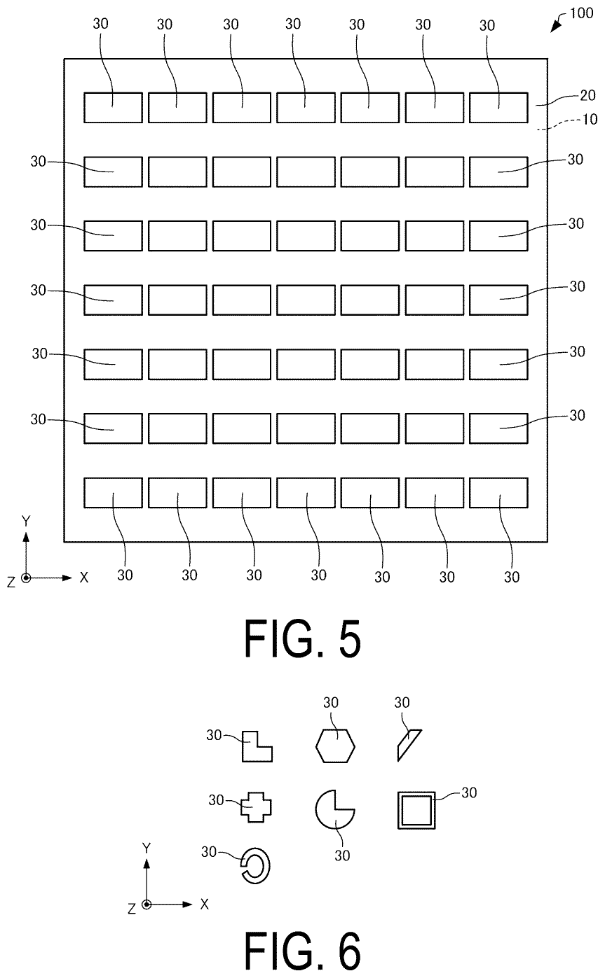

Further, the planar shape of the microstructure 30 is not limited to the circle. For example, the planar shape of the microstructure 30 may be an ellipse as illustrated in FIG. 4 or a rectangle as illustrated in FIG. 5. In addition, the microstructure 30 may have various planar shapes such as a grain shape, a polygonal shape, a ring shape, and a linear shape as illustrated in FIG. 6. Further, the plurality of microstructures 30 may be a combination of microstructures having different shapes. In this way, in the in-plane direction orthogonal to the perpendicular line Q direction, the intensity or distribution of an enhanced electric field generated the plurality of microstructures 30 may be controlled.

Although not illustrated, a plurality of recessed portions may be formed at the upper surface of the dielectric layer 20, and the microstructures 30 may be provided at the recessed portions.

The microstructure 30 has conductivity. The material of the microstructure 30 is, for example, a metal such as Al, Au, Ag, Cu, Pt, Pd, or Ni. The material of the microstructure 30 may be an alloy of these metals. The microstructure 30 may be a metal particle. The material of the microstructure 30 is not particularly limited as long as the material has a plasma frequency with respect to the light from the light source, and may be a transparent electrode such as ITO (Indium Tin Oxide) or a carbon nanotube.

The transparent layer 40 is provided on the microstructures 30 and the substrate 10. The transparent layer 40 covers the microstructures 30 and the substrate 10. The thickness of the transparent 40 is, for example, 10 nm or more and 2000 nm or less, and is preferably 20 nm or more and 1000 nm or less.

The transparent layer 40 is transparent with respect to the light from the light source. The material of the transparent layer 40 is, for example, a dielectric such as Al₂O₃, TiO₂, MgO, LiNbO₃, HfO₂, Ta₂O₅, SiON, or Si₃N₄. Note that the material of the transparent layer 40 may be polystyrene. The transparent layer 40 may be constituted by a plurality of layers. In this case, the materials of the plurality of layers may be different from each other. The refractive index of the transparent layer 40 may be the same as the refractive index of the dielectric layer 20. When the refractive index of the transparent layer 40 is the same as the refractive index of the dielectric layer 20, the Rayleigh anomaly described later is easily generated. The refractive index of the transparent layer 40 may be higher than the refractive index of the substrate 10.

The transparent layer 40 has a top surface 42. The upper surface 42 constitutes, for example, an interface between the transparent layer 40 and an air layer. In the illustrated example, the upper surface 42 is a flat surface. A target substance to be detected comes into contact with, for example, the upper surface 42.

### 1.2. Enhanced Electric Field

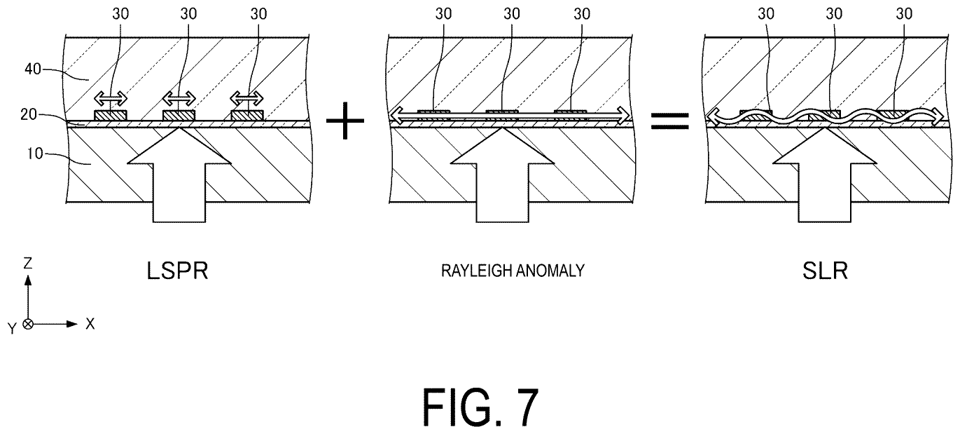

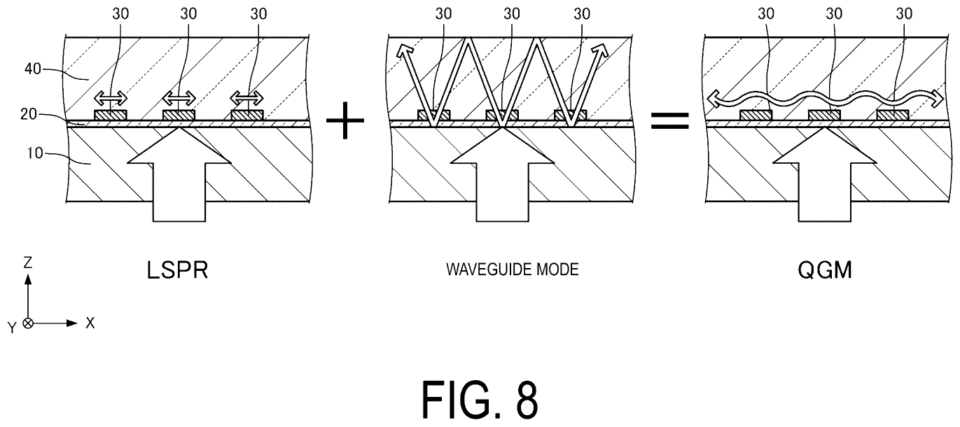

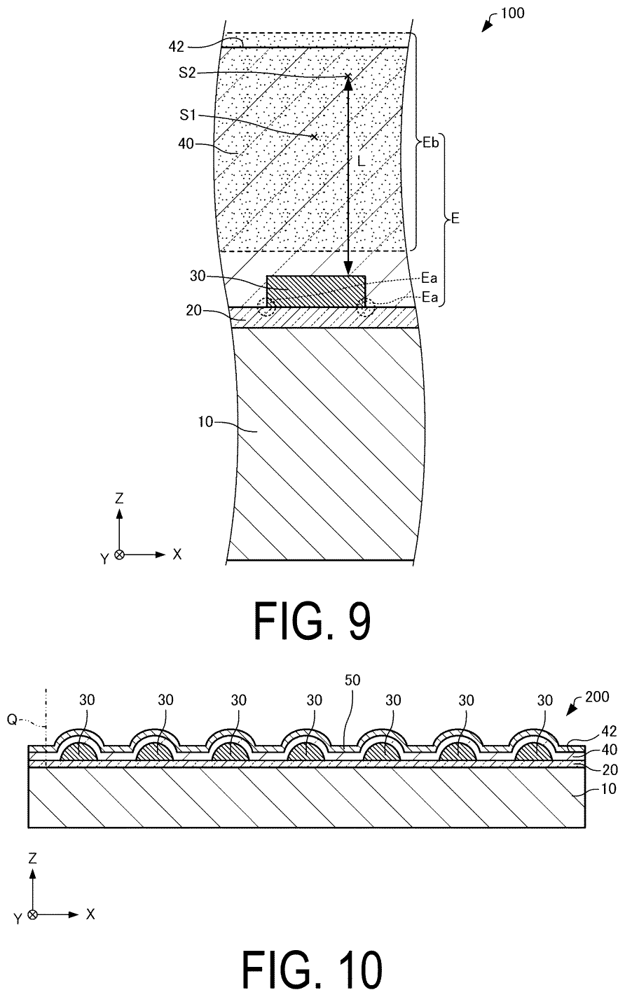

FIGS. 7 and 8 are diagrams for describing plasmon resonance in the electric field enhancing element 100. FIG. 9 is a diagram for describing an enhanced electric field E generated by the plurality of microstructures 30 of the electric field enhancing element 100.

In the examples illustrated in FIGS. 7 and 8, light is incident on the plurality of microstructures 30 from the substrate 10 side. The light incident on the microstructures 30 has a wavelength capable of causing the plurality of microstructures 30 to generate plasmon resonance. The wavelength of the light incident on the microstructures 30 is, for example, 350 nm or more and 650 nm or less.

As illustrated in FIG. 7, when the light from the light source is incident on the microstructures 30, LSPR is induced. Further, 90° diffraction by the plurality of microstructures 30, that is, the Rayleigh anomaly occurs. This Rayleigh anomaly and the LSPR are combined to induce surface lattice resonance (SLR).

Further, as illustrated in FIG. 8, light is waveguided through the transparent layer 40. This waveguide mode at the transparent layer 40 and the LSPR are combined to induce a quasi guided mode (QGM).

Then, the SLR and the QGM cooperate with each other to induce cooperative plasmon polaritons at the plurality of microstructures 30. As a result of the SLR and the QGM being combined, as illustrated in FIG. 9, the enhanced electric field E generated by the plurality of microstructures 30 includes not only a first enhanced field Ea generated at an edge of the microstructure 30 due to the LSPR, but also a second enhanced field Eb generated above the microstructure 30 due to the SLR and the QGM. The enhanced electric field E enhances the Raman scattering light and generates SERS. Due to the second enhanced field Eb, the enhanced electric field E is at the maximum at a position S1 on an opposite side of the plurality of microstructures 30 from the substrate 10 and separated from the plurality of microstructures 30, in the Z-axis direction. The fact that the enhanced electric field E is at the maximum at the position S1 is a feature of the cooperative plasmon polariton phenomenon. In the illustrated example, the position S1 is located further to the +Z-axis direction than the plurality of microstructures 30. The second enhanced field Eb may be separated from the first enhanced field Ea, or may be continuous with the first enhanced field Ea.

As illustrated in FIG. 9, the second enhanced field Eb is present at a position S2 separated from the plurality of microstructures 30 by a distance L in the Z-axis direction. The distance L may be 100 nm or 200 nm. In the illustrated example, the distance between the position S1 and the plurality of microstructures 30 in the Z-axis direction is smaller than the distance L, but may be equal to or greater than the distance L. For example, the second enhanced field Eb is present across the upper surface 42 of the transparent layer 40.

### 1.3. Effects

The electric field enhancing element 100 includes the substrate 10, the plurality of microstructures 30 having conductivity and provided at the substrate 10, and the transparent layer 40 covering the plurality of microstructures 30 and the substrate 10. The enhanced electric field E generated by the plurality of microstructures 30 is at the maximum at the position S1 on the opposite side of the plurality of microstructures 30 from the substrate 10 and separated from the plurality of microstructures 30, in the perpendicular line Q direction of the substrate 10.

Therefore, in the electric field enhancing element 100, detection sensitivity can be improved. For example, when the enhanced electric field E is generated only at the edge of the microstructure due to the LSPR, the effect of the electric field enhancement cannot be obtained unless the target substance is located in the immediate vicinity of the microstructure. In general, the probability of the target substance being located in the vicinity of the microstructure varies. Thus, when the enhanced electric field E is generated only at the edge of the microstructure, the detection sensitivity is likely to decrease. Further, detection reproducibility also deteriorates. Furthermore, when the size of the target substance is large, the target substance cannot enter between the microstructures adjacent to each other, and it may be thus difficult to locate the target substance in the vicinity of the microstructure.

As described above, in the electric field enhancing element 100, the enhanced electric field E generated by the plurality of microstructures 30 is at the maximum at the position S1 on the opposite side of the plurality of microstructures 30 from the substrate 10 and separated from the plurality of microstructures 30, in the perpendicular line Q direction. Thus, a detection signal triggered by the target substance can be enhanced even when the target substance is not located in the immediate vicinity of the microstructure 30. As a result, the detection sensitivity can be improved. In addition, viruses, bacteria, and like can be freely selected as the target substance.

Furthermore, in the electric field enhancing element 100, as described above, since the target substance does not need to be located in the immediate vicinity of the microstructure 30, the transparent layer 40 covering the microstructures 30 can be provided. Thus, changes in chemical properties such as oxidation and sulfurization of the microstructures 30 can be suppressed. In particular, Ag is susceptible to oxidation, sulfurization, transformation such as migration, and deformation. In the electric field enhancing element 100, even when Ag is used as the microstructures 30, such transformation and deformation can be suppressed. As a result, durability and reliability can be improved.

Furthermore, in the electric field enhancing element 100, unevenness caused by the plurality of microstructures 30 can be reduced by the transparent layer 40. Therefore, flatness of the surface with which the target substance comes into contact can be improved. As a result, it is possible to reduce variations in the detection signals triggered by the target substance in the in-plane direction.

In the electric field enhancing element 100, the transparent layer 40 is provided between the adjacent microstructures 30 among the plurality of microstructures 30, and the refractive index of the transparent layer 40 is higher than the refractive index of the substrate 10. Therefore, in the electric field enhancing element 100, for example, compared with a case in which the refractive index of the transparent layer is lower than the refractive index of the substrate, light is more easily collected at the positions of the plurality of microstructures 30 in the perpendicular line Q direction. As a result, the QGM is easily induced.

In the electric field enhancing element 100, the enhanced electric field E is present at the position S2 on the opposite side of the plurality of microstructures 30 from the substrate 10 and separated from the plurality of microstructures 30 by 100 nm, in the perpendicular line Q direction. Therefore, in the electric field enhancing element 100, it is possible to enhance the detection signal triggered by the target substance even when the target substance is not located in the immediate vicinity of the microstructure 30.

In the electric field enhancing element 100, the enhanced electric field E is present at the position S2 on the opposite side of the plurality of microstructures 30 from the substrate 10 and separated from the plurality of microstructures 30 by 200 nm, in the perpendicular line Q direction. Therefore, in the electric field enhancing element 100, it is possible to enhance the detection signal triggered by the target substance even when the target substance is not located in the immediate vicinity of the microstructure 30.

In the electric field enhancing element 100, the plurality of microstructures 30 are periodically arrayed. Therefore, in the electric field enhancing element 100, it is possible to reduce variations in the intensity of the enhanced electric field E in the in-plane direction. When the plurality of microstructures are randomly arranged, only microstructures having a pitch and a diameter that match the wavelength of the light from the light source induce the LSPR, and thus the intensity of the enhanced electric field E varies in the in-plane direction. Furthermore, in the electric field enhancing element 100, since the plurality of microstructures 30 are periodically arrayed, the SLR is easily induced.

### 2. Method for Manufacturing Electric Field Enhancing Element

Next, a method for manufacturing the electric field enhancing element 100 according to the embodiment will be described with reference to the drawings.

As illustrated in FIG. 1, the dielectric layer 20 is formed on the substrate 10. The dielectric layer 20 is formed by, for example, a vapor deposition method, a sputtering method, a chemical vapor deposition (CVD) method, or an atomic layer deposition (ALD) method.

Subsequently, the plurality of microstructures 30 are formed on the dielectric layer 20. The microstructures 30 are formed by, for example, forming a thin film by a vacuum deposition method, the sputtering method, or the like, and then patterning the thin film. Examples of the patterning include photolithography and etching, a microcontact printing method, and a nanoimprint method.

Subsequently, the transparent layer 40 is formed on the dielectric layer 20 and the microstructures 30. The transparent layer 40 is formed by, for example, the vapor deposition method, the sputtering method, the CVD method, or the ALD method.

The electric field enhancing element 100 can be manufactured by performing the steps described above.

### 3. Modified Example of Electric Field Enhancing Element

Next, an electric field enhancing element according to a modified example of the embodiment will be described with reference to the drawings. FIG. 10 is a cross-sectional view schematically illustrating an electric field enhancing element 200 according to a modified example of the embodiment. In the following description, in the electric field enhancing element 200 according to the modified example of the embodiment, members having the same functions as those of the constituent members of the electric field enhancing element 100 according to the embodiment described above will be denoted with the same reference signs, and detailed description thereof will be omitted.

As illustrated in FIG. 10, the electric field enhancing element 200 is different from the above-described electric field enhancing element 100 in that a molecule capturing layer 50 is provided in the electric field enhancing element 200.

The molecule capturing layer 50 is provided on the transparent layer 40. The molecule capturing layer 50 is in contact with the transparent layer 40. The molecule capturing layer 50 is an organic molecular film. The molecule capturing layer 50 is, for example, a self-assembled monolayer (SAM). The thickness of the molecule capturing layer 50 is, for example, 0.1 nm or more and 1 nm or less, and is preferably 0.4 nm or less. The molecule capturing layer 50 has a function of capturing the target substance. The molecule capturing layer 50 is appropriately selected in accordance with the type of the target substance, and examples thereof include an alkanethiol film and a silane coupling agent. The molecule capturing layer 50 is formed by, for example, a liquid immersion method, the vacuum deposition method, a molecular vapor deposition (MVD) method, or the CVD method.

In the electric field enhancing element 200, since the molecule capturing layer 50 is provided on the transparent layer 40, film unevenness occurring at a time of forming the molecule capturing layer 50 can be reduced. For example, in a case in which the transparent layer is not provided and the molecule capturing layer is formed directly on the microstructures and the substrate, the physical and chemical states of the surfaces of the microstructures and the surface of the substrate become different from each other. This may result in the film unevenness of the molecule capturing layer.

Furthermore, in the electric field enhancing element 200, as described above, since the target substance does not need to be located in the immediate vicinity of the microstructure 30, selectivity of the molecular chain length of the molecule capturing layer 50 is widened. Note that, although not illustrated, a primer layer may be provided between the transparent layer 40 and the molecule capturing layer 50 to improve adhesion therebetween.

In the illustrated example, the shape of the microstructure is a semicircle. Note that the cross-sectional shape of the microstructure 30 is not particularly limited, and may be, for example, a trapezoidal shape, a circular shape, a reverse-tapered shape, or a tip ball shape. The shape of the microstructure 30 may be a truncated quadrangular pyramid shape or a cone shape.

### 4. Raman Spectroscopic Device

### 4.1. Configuration

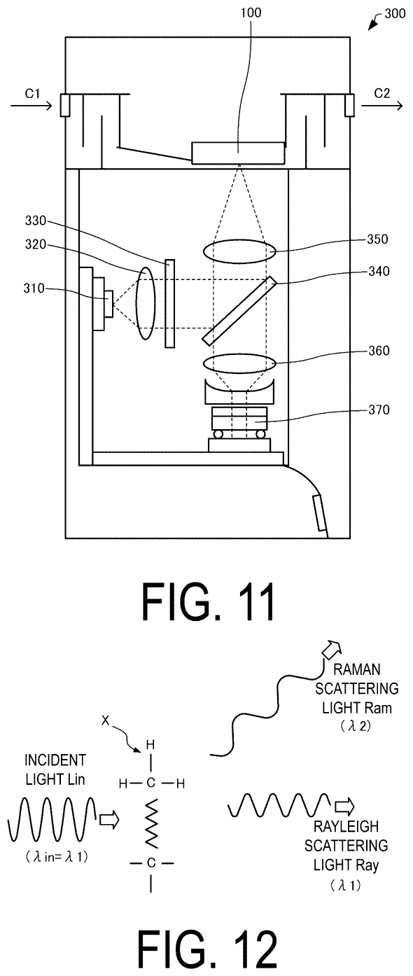

Next, a Raman spectroscopic device according to the embodiment will be described with reference to the drawings. FIG. 11 is a diagram schematically illustrating a Raman spectroscopic device 300 according to the embodiment.

As illustrated in FIG. 11, the Raman spectroscopic device 300 includes, for example, the electric field enhancing element 100, a light source 310, a collimator lens 320, a polarization control element 330, a dichroic mirror 340, an objective lens 350, a condensing lens 360, and a detector 370. Note that in FIG. 11, for the sake of convenience, the electric field enhancing element 100 is illustrated in a simplified manner.

The target substance is carried into the Raman spectroscopic device 300 from a C1 direction and carried out in a C2 direction. For example, by controlling the driving of a fan (not illustrated), the target substance is introduced from an inlet port to the inside of a transport unit and discharged from a discharge port to the outside of the transport unit.

The light source 310 irradiates the electric field enhancing element 100 with light. The light emitted from the light source 310 has a wavelength that induces the SLR and the QGM in the electric field enhancing element 100. As the light source 310, for example, a laser or a light emitting diode (LED) is used. Examples of the laser include a vertical cavity surface emitting laser (VCSEL) and a photonic crystal surface emitting laser (PCSEL).

The light emitted from the light source 310 is, for example, collimated by the collimator lens 320, passes through the polarization control element 330, and is guided in the direction toward the electric field enhancing element 100 by the dichroic mirror 340. The light traveling toward the electric field enhancing element 100 is condensed by the objective lens 350, and enters the electric field enhancing element 100. At this time, the target substance is in contact with the transparent layer 40 of the electric field enhancing element 100.

When light is incident on the electric field enhancing element 100, the enhanced electric field E is generated by the plurality of microstructures 30. When the target substance is located in the enhanced electric field E, SERS light is generated therefrom. The SERS light passes through the objective lens 350 and is directed by the dichroic mirror 340 in the direction toward the detector 370. The SERS light traveling toward the detector 370 is condensed by the condenser lens 360 and enters the detector 370.

The detector 370 detects the SERS light from the electric field enhancing element 100. The detector 370 is, for example, a diffraction grating spectrometer. Then, in the Raman spectroscopic device 300, the SERS light is spectrally resolved by the detector 370 to obtain spectral information. The detector 370 may be a Fabry Perot etalon spectrometer.

### 4.2. Principle

FIG. 12 is a diagram for describing a principle of a Raman scattering spectroscopy method.

As illustrated in FIG. 12, for example, when a target substance X is irradiated with light Lin having a wavelength λin, in the scattering light, in addition to Rayleigh scattering light Ray having a wavelength λ1, which is the same as the wavelength λin of the incident light Lin, Raman scattering light Ram having a wavelength λ2 different from the wavelength λ1 is generated. The energy difference between the Raman scattering light Ram and the incident light Lin corresponds to the energy of the vibrational level, the rotational level, or the electronic level of the target substance X. Since the target substance X has a specific vibration energy corresponding to the structure thereof, the target substance X can be specified by using the light Lin having the wavelength λin.

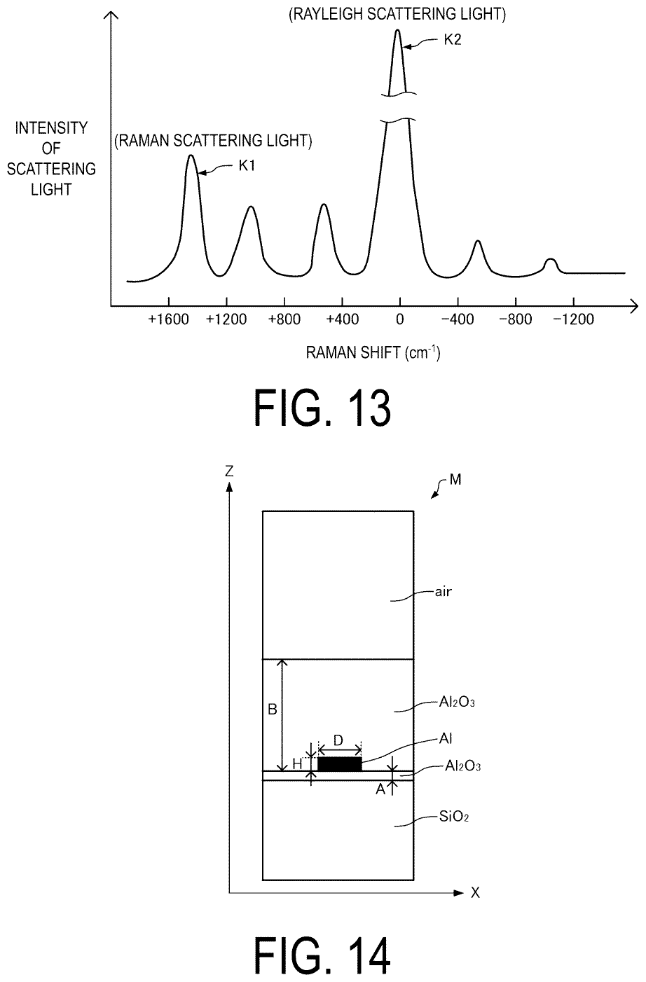

FIG. 13 is a schematic diagram showing an example of a Raman spectrum obtained by Raman scattering spectroscopy. In FIG. 13, the horizontal axis represents a Raman shift. The Raman shift is a difference between the wave number (frequency) of the Raman scattering light Ram and the wave number of the incident light Lin, and takes a value specific to a molecular bonded state of the target substance X.

As illustrated in FIG. 13, when the scattering intensity of the Raman scattering light Ram indicated by K1 is compared with the scattering intensity of the Rayleigh scattering light Ray indicated by K2, it is understood that the Raman scattering light Ram is weaker. In this way, the Raman scattering spectroscopy method is a measurement method having an excellent capability for identifying the target substance X, but the sensitivity itself for detecting the target substance X is low. Therefore, in the Raman spectroscopic device 300, a high sensitivity is achieved by using the SERS.

### 1.3. Effects

The Raman spectroscopic device 300 includes the electric field enhancing element 100, the light source 310 that irradiates the electric field enhancing element 100 with light, and the detector 370 that detects light from the electric field enhancing element 100. As described above, the electric field enhancing element 100 can improve the detection sensitivity. Therefore, the detection sensitivity is high in the Raman spectroscopic device 300.

### 4. Experimental Examples

### 5.1 Model

### Example 1

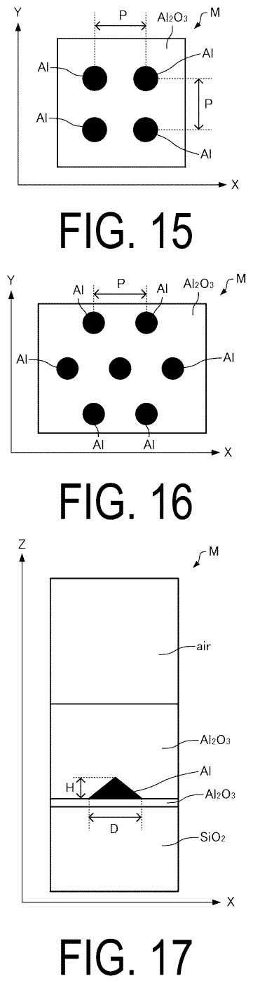

FIG. 14 is an XZ cross-sectional view schematically illustrating a model M used in a simulation. FIG. 15 is an XY cross-sectional view schematically illustrating the model M used in the simulation.

In the model M, as illustrated in FIG. 14, the material of the substrate was SiO₂. Light was incident on the model M from the substrate side. The wavelength of the incident light was set to 578 nm.

The material of the dielectric layer was Al₂O₃. A thickness A of the dielectric layer was set to 20 nm.

The material of the microstructure was Al. As illustrated in FIG. 15, the microstructures were arrayed in a square lattice pattern. The shape of the microstructure was a cylindrical shape. A pitch P of the microstructure was set to 391 nm, a diameter D of the microstructure was set to 156 nm, and a thickness H of the microstructure was set to 20 nm.

The material of the transparent layer was Al₂O₃. A thickness B of the transparent layer was set to 360 nm. The air layer was disposed on the transparent layer.

### Example 2

Example 2 is the same as Example 1 except that the thickness H of the microstructure was set to 200 nm and the wavelength of the incident light was set to 432 nm.

### Example 3

Example 3 is the same as Example 1 except that the diameters D of the microstructure was set to 39 nm, the thickness H of the microstructure was set to 60 nm, and the wavelength of the incident light was set to 410 nm.

### Example 4

Example 4 is the same as Example 1 except that the diameter D of the microstructure was set to 352 nm, the thickness H of the microstructure was set to 60 nm, and the wavelength of the incident light was set to 571 nm.

### Example 5

Example 5 is the same as Example 1 except that the thickness A of the dielectric layer was 0, that is, the dielectric layer was not provided, the diameter D of the microstructure was set to 39 nm, the thickness H of the microstructure was set to 60 nm, and the wavelength of the incident light was set to 408 nm.

### Example 6

Example 6 is the same as Example 1 except that the thickness of the dielectric layer was set to 1000 nm, the diameters D of the microstructure was set to 39 nm, the thickness H of the microstructure was set to 60 nm, and the wavelength of the incident light was set to 576 nm.

### Embodiment 7

Example 7 is the same as Example 1 except that the thickness H of the microstructure was set to 19 nm, the thickness B of the transparent layer was set to 20 nm, and the wavelength of the incident light was set to 412 nm.

### Example 8

Example 8 is the same as Example 1 except that the thickness H of the microstructure was set to 19 nm, the thickness B of the transparent layer was set to 1000 nm, and the wavelength of the incident light was set to 404 nm.

### Example 9

Example 9 is the same as Example 1 except that the pitch P of the microstructure was set to 278 nm, the material of the dielectric layer was TiO₂, the diameter D of the microstructure was set to 111 nm, the thickness H of the microstructure was set to 60 nm, and the wavelength of the incident light was set to 426 nm.

### Example 10

Example 10 is the same as Example 1 except that the pitch P of the microstructure was set to 365 nm, the material of the dielectric layer was MgO, the diameter D of the microstructure was set to 146 nm, the thickness H of the microstructure was set to 60 nm, and the wavelength of the incident light was set to 568 nm.

### Example 11

Example 11 is the same as Example 1 except that the material of the microstructure was Au, the diameter D of the microstructure was set to 196 nm, the thickness H of the microstructure was set to 60 nm, and the wavelength of the incident light was set to 583 nm.

### Example 12

Example 12 is the same as Example 1 except that the material of the microstructure was ITO, the diameter D of the microstructure was set to 235 nm, the thickness H of the microstructure was set to 60 nm, and the wavelength of the incident light was set to 413 nm.

### Example 13

Example 13 is the same as Example 1 except that the pitch P of the microstructure was set to 246 nm, the diameter D of the microstructure was set to 98 nm, the thickness H of the microstructure was set to 60 nm, and the wavelength of the incident light was set to 386 nm.

### Example 14

Example 14 is the same as Example 1 except that the pitch P of the microstructure was set to 829 nm, the diameter D of the microstructure was set to 332 nm, the thickness H of the microstructure was set to 60 nm, and the wavelength of the incident light was set to 638 nm.

### Example 15

Example 15 is the same as Example 1 except that the microstructures were arrayed in a triangular lattice pattern as illustrated in FIG. 16, the thickness H of the microstructure was set to 60 nm, and the wavelength of the incident light was 505 nm.

### Example 16

Example 16 is the same as Example 1 except that the shape of the microstructure was a cone shape as illustrated in FIG. 17, the thickness H of the microstructure was set to 60 nm, and the wavelength of the incident light was set to 576 nm.

### Comparative Example 1

Comparative Example 1 is the same as Example 1 except that the thickness A of the dielectric layer was 0, that is, the dielectric layer was not provided, the thickness B of the transparent layer was 0, that is, the transparent layer was not provided, the material of the microstructure was Ag, the pitch P of the microstructure was set to 250 nm, the diameter D of the microstructure was set to 50 nm, the thickness H of the microstructure was set to 25 nm, and the wavelength of the incident light was set to 464 nm.

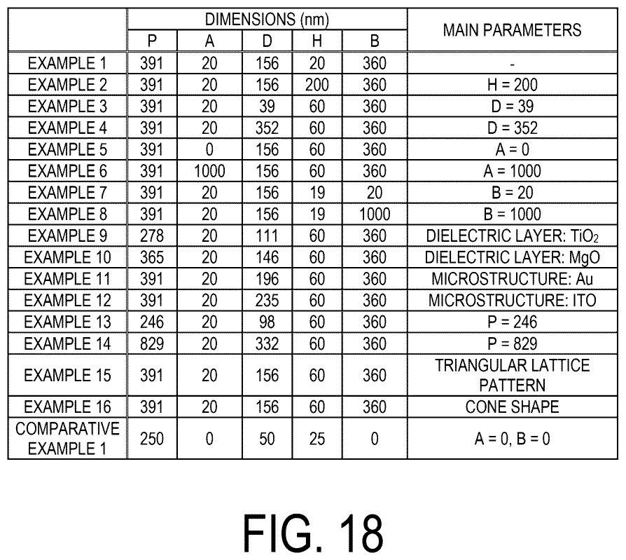

FIG. 18 is a table showing dimensions, and main parameters changed in Examples 1 to 16 and Comparative Example 1 described above.

### 5.2. Simulation Results

In each of Examples 1 to 16 and Comparative Example 1 as described above, simulation was performed on the distribution of the enhanced electric field. A finite difference time domain (FDTD) method was used for the simulation.

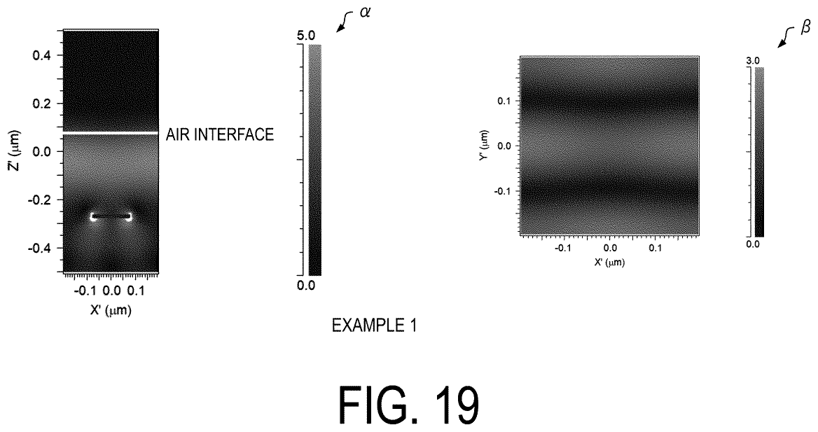

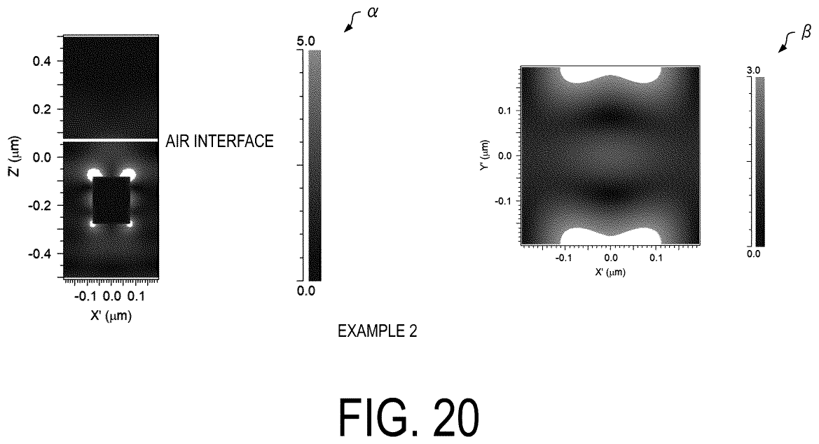

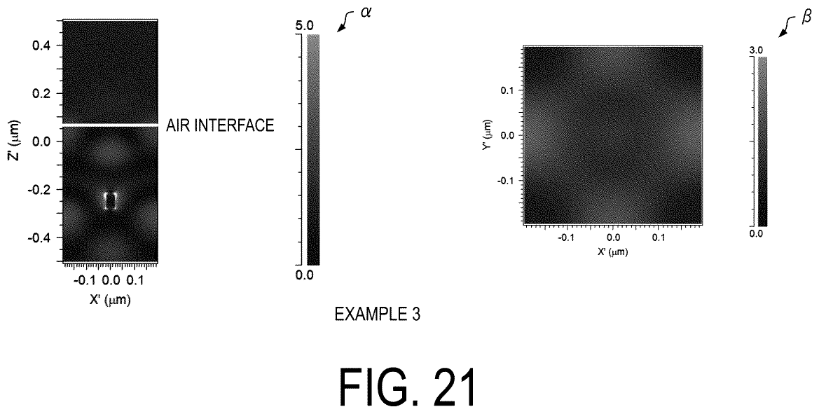

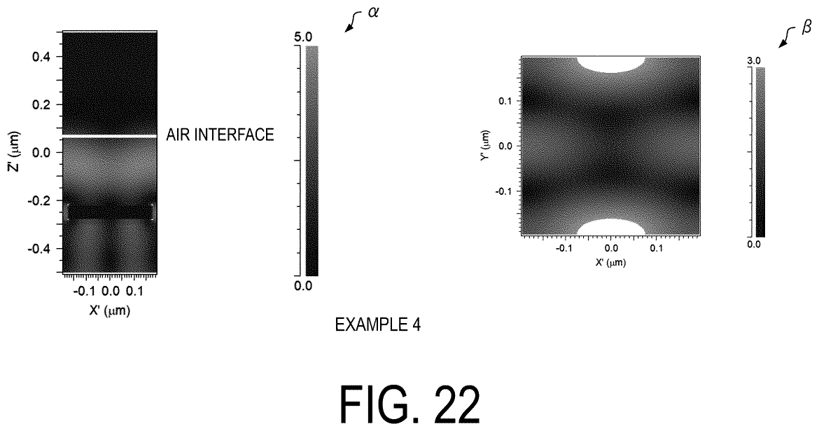

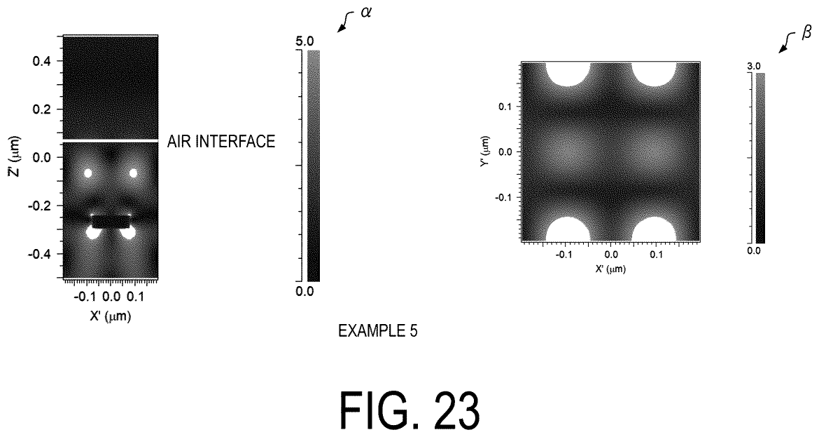

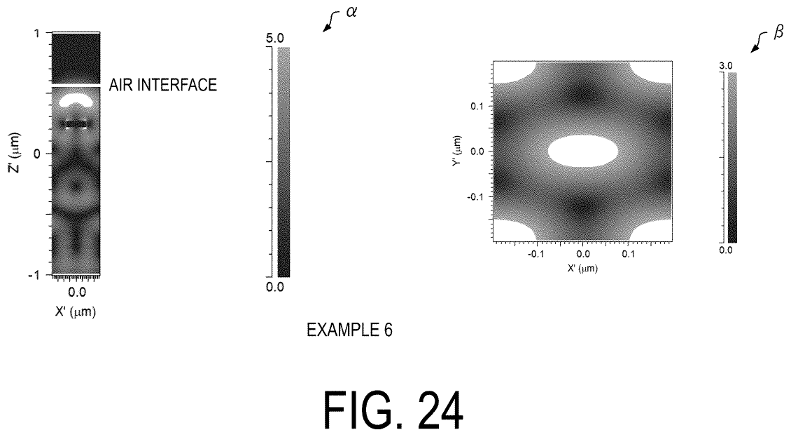

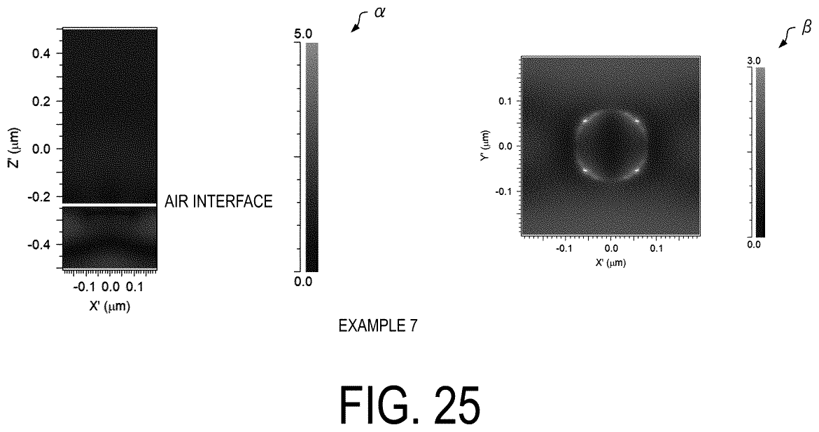

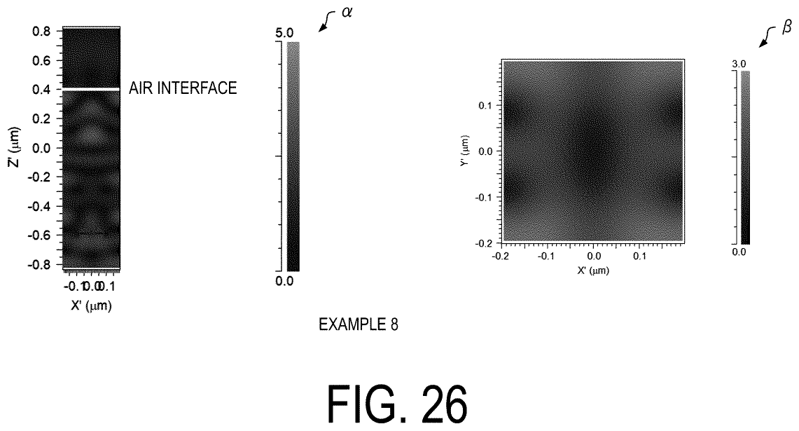

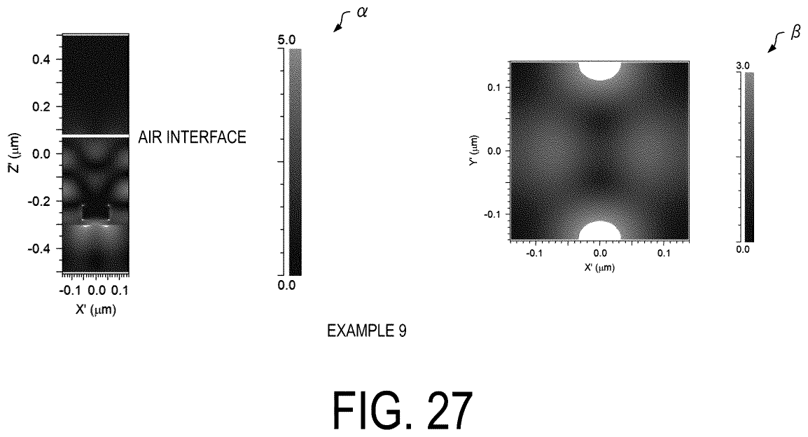

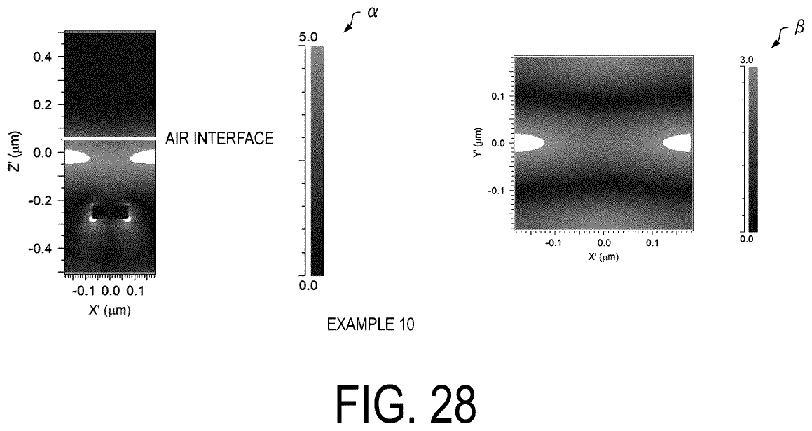

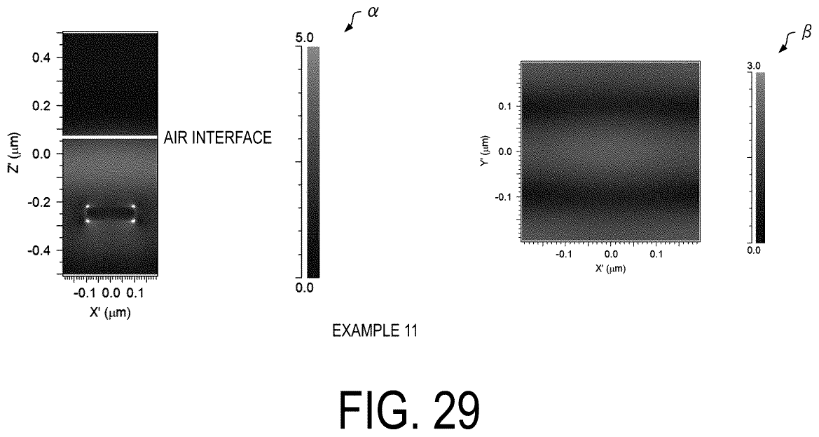

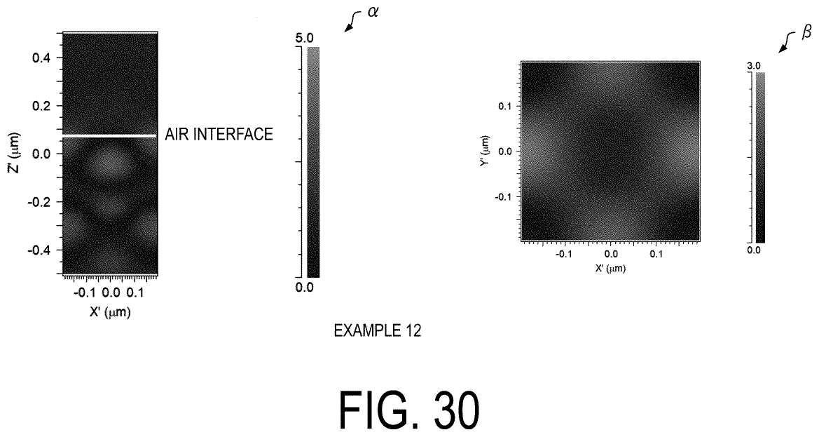

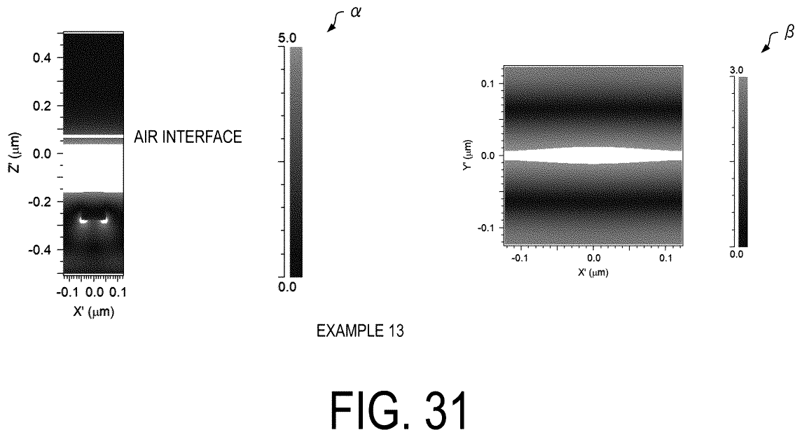

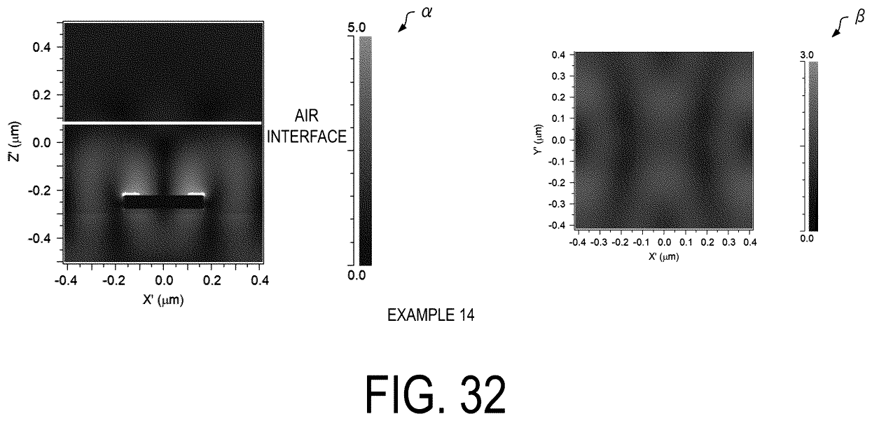

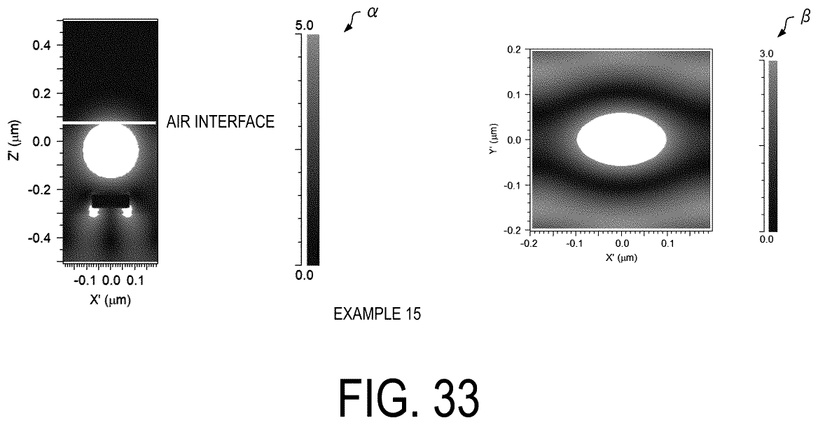

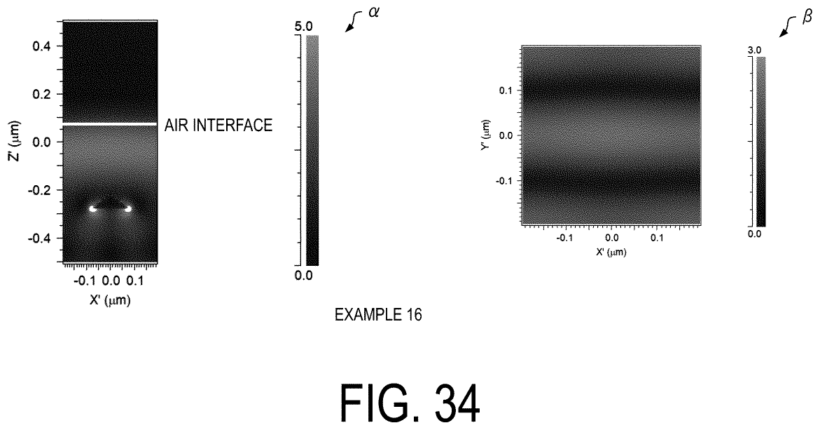

FIGS. 19 to 35 show simulation results of Examples 1 to 16 and Comparative Example 1, respectively. FIGS. 19 to 35 show the distribution of the normalized enhanced electric field.

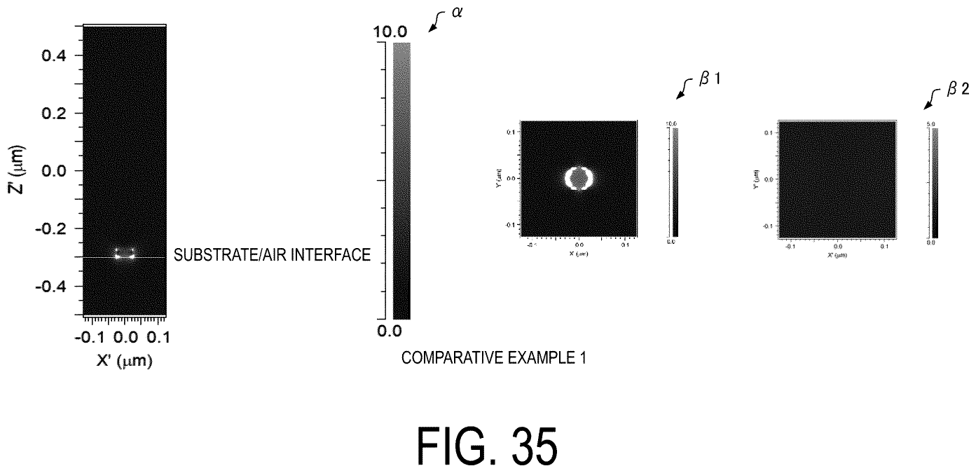

In FIGS. 19 to 35, α indicates the distribution of the enhanced electric field in an XZ cross-section. Specifically, α indicates the square root of (Ex²+Ez²), that is, √(Ex²+Ez²). In FIGS. 19 to 34, “air interface” indicates an interface between the transparent layer and the air layer. In FIG. 35, “substrate/air interface” indicates an interface between the substrate and the air layer.

In FIGS. 19 to 35, β indicates the distribution of the enhanced electric field in an XY cross-section. Specifically, B indicates the square root of (Ex²+Ez²), that is, √(Ex²+Ez²). In FIGS. 19 to 34, β indicates an XY cross-section taken at a position shifted to the +Z-axis direction by 1 nm from the “air interface” indicated by a. In FIG. 35, β1 indicates an XY cross-section taken at a position shifted to the +Z-axis direction by 1 nm from the “air interface” indicated by α, and β2 indicates an XY cross-section taken at a position shifted to the +Z-axis direction by 100 nm from the “substrate/air interface” indicated by α.

As indicated by β in FIGS. 19 to 34, in Examples 1 to 16, a specific pattern was observed at a position separated from the air interface by 1 nm in the upward direction. This is because the enhanced electric field is located above the air interface due to the SLR and the QGM induced by the microstructures. As shown in FIGS. 19 to 34, it was found that the enhanced electric field was present at a position separated from the microstructures by 100 nm in the upward direction, and also at a position separated from the microstructures by 200 nm in the upward direction.

On the other hand, as indicated by β2 in FIG. 35, in Comparative Example 1, no pattern was observed at the position separated from the substrate/air interface by 100 nm in the upward direction, and no enhanced electric field was present.

The embodiment and the modified example described above are examples and are not intended as limiting. For example, each embodiment and each modified example can also be combined together as appropriate.

The present disclosure includes configurations that are substantially identical to the configurations described in the embodiment, for example, configurations with identical functions, methods and results, or with identical objects and effects. Also, the present disclosure includes configurations obtained by replacing non-essential portions of the configurations described in the embodiment. In addition, the present disclosure includes configurations having the same operations and effects or can achieve the same objects as the configurations described in the embodiment. Further, the present disclosure includes configurations obtained by adding known techniques to the configurations described in the embodiment.

The following content is derived from the embodiment and the modified example described above.

An aspect of an electric field enhancing element includes a substrate, a plurality of microstructures provided at the substrate and having conductivity, and a transparent layer covering the plurality of microstructures and the substrate. An enhanced electric field generated by the plurality of microstructures is at a maximum at a position on an opposite side of the plurality of microstructures from the substrate and separated from the plurality of microstructures, in a perpendicular line direction of the substrate.

According to the electric field enhancing element, the detection sensitivity can be improved.

In an aspect of the electric field enhancing element, the transparent layer may be provided between adjacent microstructures among the plurality of microstructures, and a refractive index of the transparent layer may be higher than a refractive index of the substrate.

According to the electric field enhancing element, light is easily collected at the positions of the plurality of microstructures in the perpendicular line direction of the substrate.

In an aspect of the electric field enhancing element, the enhanced electric field may be present at a position separated from the plurality of microstructures by 100 nm or more in the perpendicular line direction.

According to the electric field enhancing element, it is possible to enhance the detection signal triggered by the target substance even if the target substance is not located in the immediate vicinity of the microstructure.

In an aspect of the electric field enhancing element, the enhanced electric field may be present at a position separated from the plurality of microstructures by 200 nm or more in the perpendicular line direction.

According to this electric field enhancing element, it is possible to enhance the detection signal triggered by the target substance even if the target substance is not located in the immediate vicinity of the microstructure.

In an aspect of the electric field enhancing element, the plurality of microstructures may be periodically arrayed.

According to the electric field enhancing element, it is possible to reduce variations in the intensity of the enhanced electric field in the in-plane direction orthogonal to the perpendicular line direction of the substrate.

In an aspect of the electric field enhancing element, a material of each of the plurality of microstructures may be a metal.

In an aspect of the electric field enhancing element, a material of the transparent layer may be a dielectric.

An aspect of a Raman spectroscopic device includes an aspect of the electric field enhancing element, a light source configured to irradiate the electric field enhancing element with light, and a detector configured to detect light from the electric field enhancing element.

According to the Raman spectroscopic device, the detection sensitivity becomes high.

What is claimed is:

1. An electric field enhancing element, comprising:
a substrate;
a plurality of microstructures provided at the substrate and having conductivity; and
a transparent layer covering the plurality of microstructures and the substrate, wherein
an enhanced electric field generated by the plurality of microstructures is at a maximum at a position on an opposite side of the plurality of microstructures from the substrate and separated from the plurality of microstructures, in a perpendicular line direction of the substrate.

2. The electric field enhancing element according to claim 1, wherein
the transparent layer is provided between adjacent microstructures among the plurality of microstructures, and
a refractive index of the transparent layer is higher than a refractive index of the substrate.

3. The electric field enhancing element according to claim 1, wherein
the enhanced electric field is present at a position separated from the plurality of microstructures by 100 nm or more in the perpendicular line direction.

4. The electric field enhancing element according to claim 1, wherein
the enhanced electric field is present at a position separated from the plurality of microstructures by 200 nm or more in the perpendicular line direction.

5. The electric field enhancing element according to claim 1, wherein
the plurality of microstructures are periodically arrayed.

6. The electric field enhancing element according to claim 1, wherein
a material of each of the plurality of microstructures is a metal.

7. The electric field enhancing element according to claim 1, wherein
a material of the transparent layer is a dielectric.

8. A Raman spectroscopic device, comprising:
the electric field enhancing element according to claim 1;
a light source configured to irradiate the electric field enhancing element with light; and
a detector configured to detect light from the electric field enhancing element.
